(19) United States
(12) Patent Application Publication
(10) Pub. No.: US 2023/0144822 A1
(43) Pub. Date: May 11, 2023

(54) METHOD AND APPARATUS FOR MANUFACTURING 3D METAL PARTS

(71) Applicant: AML3D LIMITED, South Australia (AU)

(72) Inventor: Andrew Michael Clayton SALES, South Australia (AU)

(21) Appl. No.: 18/083,382

(22) Filed: Dec. 16, 2022

Related U.S. Application Data
(63) Continuation of application No. 16/624,185, filed on Dec. 18, 2019, now abandoned.

(30) Foreign Application Priority Data
Apr. 14, 2018 (AU) 2018901257

(51) Int. Cl. B23K 9/04; B33Y 10/00; B33Y 30/00; B33Y 50/02; B23K 9/095; B23K 9/12; B23K 9/16; B23K 9/167; B23K 9/173; B23K 9/235; B23K 9/32; B23K 10/02; B23K 37/00; B23K 37/02; B25J 9/06; H05B 6/10

(52) U.S. Cl. CPC B23K 9/042; B23K 9/124; B23K 9/164; B23K 9/167; B23K 9/173; B23K 9/235; B23K 9/325; B23K 9/0953; B23K 10/027; B23K 37/003; B23K 37/0229; B25J 9/06; B33Y 10/00; B33Y 30/00; B33Y 50/02; H05B 6/101; B23K 2103/04

(57) ABSTRACT

A method of manufacturing a metallic part in a weldable material by solid freeform fabrication comprising generating three dimensional model of the part, slicing the three dimensional model into a set of parallel, sliced layers and then dividing each layer into a set of one-dimensional pieces and, with reference to layered weld-bead geometry data, forming a computer-generated, direction specific, layered model of the part. The method also comprises uploading the layered model into a welding control system and directing the welding control system to deposit a sequence of one-dimensional weld beads of the weldable material onto the supporting substrate in a pattern required to form a first layer of the layered model and depositing a second welded layer onto the previous deposited layer in a configuration the same as the second layer, and repeating each successive weld bead until the entire part is completed. The method further includes displacing the atmosphere within the immediate vicinity of the heat source with an inert gas atmosphere which produces a required flow rate, and in which that inert atmosphere contains a maximum oxygen concentration, wherein the inert gas is delivered by an apparatus through a matrix of individual gas diffusers; and engaging an induction heating and closed loop cooling apparatus synergic to a welding control system and pre-heating the substrate material including the deposited weld beads, relevant to the type of weldable material, wherein induction heating and cooling cycles are applied constantly or pulsed from the first layer to the final layer, where optimal heating and/or cooling cycles of the weldable material are relative to the final desired part shape and microstructure.

### CROSS-REFERENCE TO RELATED APPLICATIONS

This application is a continuation of U.S. Pat. Application No. 16/624,185 filed Dec. 18, 2019, which is a U.S. national phase application filed under 35 U.S.C. § 371 of International Application No. PCT/AU2019/050269, filed Mar. 26, 2019 designating the United States, which claims priority from Australian Application Number 2018901257, filed Apr. 14, 2018, the entire contents of which are incorporated herein by reference.

### FIELD OF THE INVENTION

This invention relates to a method and apparatus for manufacturing weldable metallic objects by solid freeform fabrication.

### BACKGROUND OF THE INVENTION

Metallic parts, including machine and structural components, that are made from any material type for an engineered use are usually made by casting, forging, rolling and machining from an ingot or billet. These methods are normally disadvantaged by a high percentage of material wastage when finishing the part to its final shape. Additionally, these methods enhance delivery times for the delivery of the completed parts.

Metallic parts that are completely dense in their physical form can also be manufactured using technologies identified as additive manufacturing, rapid prototyping, rapid manufacturing, layered manufacturing or additive fabrication. This method of manufacture encompasses the use of computer aided design software (CAD) to initially develop a computer-generated model of the part to be manufactured, then to convert the computer-generated model into thin parallel layers which are normally in a horizontal plane. The metallic part is then manufactured by layering successive material in the form of a consumable powder fusing each layer together sequentially until a final shape is formed that resembles the CAD model. This method is also commonly referred to as 3D printing, solid freeform fabrication, rapid prototyping or wire-arc additive manufacturing.

The method described in the preceding paragraph allows manufacturing of metallic parts of nearly any shape with the advantages of increased production times, depending on the size of each metallic part. The method is normally restricted for prototypes, low volume production and small production runs, but is less suited to large parts and high volume manufacture.

Before turning to a summary of the solution provided by the present invention, it should be appreciated that reference to any prior art in this specification is not, and should not be taken as, an acknowledgment or any form of suggestion that this prior art forms part of the common general knowledge in any country.

### SUMMARY OF THE INVENTION

In one aspect, the present invention provides a method of manufacturing a metallic part in a weldable material by solid freeform fabrication unrestricted in size and open to the ambient atmosphere, wherein the method comprises:
generating a computer-generated, three dimensional model of the part, slicing the computer-generated, three dimensional model into a set of computer-generated, parallel sliced layers and then dividing each layer into a set of computer-generated, virtual, one-dimensional pieces and, with reference to layered weld-bead geometry data, forming a computer-generated, direction specific, layered model of the part,
uploading the direction specific, layered model of the part into a welding control system able to control the position and activation relative to a support substrate, of an electric arc delivered by a high energy tungsten arc welding torch, a plasma transferred arc welding torch, and/or a gas metal arc welding torch, and a system for feeding a consumable wire placed in an open area build space relevant to the substrate unrestricted in size and open to the ambient atmosphere,
directing the welding control system to deposit a sequence of one-dimensional weld beads of the weldable material onto the supporting substrate in a pattern required to form a first layer of the computer-generated direction specific layered model of the part,
depositing a second welded layer by sequencing one-dimensional weld beads of the weldable material onto the previous deposited layer in a configuration the same as the second layer of the computer-generated direction specific layered model of the part, and
repeating each successive weld bead layer of the computer-generated, direction specific, layered model of the part until the entire part is completed;
wherein the method further includes one or both of:
   displacing the atmosphere within the immediate vicinity of the heat source with an inert gas atmosphere which produces a required flow rate, and in which the inert atmosphere contains a maximum oxygen concentration, wherein the inert gas is delivered by an apparatus through a matrix of individual gas diffusers and/or a filter; and
   engaging an induction heating and closed loop cooling apparatus synergic to a welding control system and pre-heating the substrate material including the deposited weld beads, relevant to the type of weldable material, wherein induction heating and cooling cycles are applied constantly or pulsed from the first layer to the final layer, where optimal heating and/or cooling cycles of the weldable material are relative to the final desired part shape and microstructure.

In another aspect, the present invention provides a production apparatus for a part made of a weldable material by solid freeform fabrication, where there is no enclosure or reactor required, and the part is built in an unrestricted build environment open to the ambient atmosphere by an apparatus which distributes an inert gas flow, the production apparatus including:
a robotic multiple-axis mechanism controlling the position and movement of a welding torch with a wire feeder relative to a stationary support substrate placed upon a fixed support, the welding torch being an electric arc welding process, a tungsten arc welding torch, a gas metal arc welding torch, or a plasma transferred arc welding torch;
a support mechanism controlling the position and movement of the welding torch with the wire feeder relative to the support substrate, with an actuator controlling the position and movement relative to the support mechanism; and
a control system able to read a computer-generated, three dimensional, direction specific, layered model of the part and employ the computer-generated model to control the position and movement of the robot, and the operation of the welding torch and wire feeder, such that the part is built by welding in a layer-by-layer sequence according to the one-dimensional slices of the weldable material onto the substrate in agreement with the computer-generated, three dimensional, direction specific, layered model of the part;
the apparatus also including one or both of a localised purging apparatus and an induction heating and closed loop cooling apparatus.

In a preferred form, the required flow rate mentioned above is greater than 20 l/min. In another preferred form, the maximum oxygen concentration mentioned above is less than 500 ppm oxygen or alternatively is less than 100 ppm oxygen. In yet another preferred form, there are less than 25 of the individual gas diffusers mentioned above.

The invention thus provides a method and apparatus for increased deposition of manufactured metallic parts in weldable ferrous and non-ferrous metals, including their alloys, which are not restricted to the build size of a part.

The invention may include localised gas flow distribution in relation to the weld zone and melted metal to minimise surface contamination as an alternative to current practices involving atmospheric oxygen surrounding the weld zone and melted metal.

The invention may also include controlled heating and cooling through constant or intermittent temperature control using induction heating and a closed loop cooling system, which can be maintained during the build process and provide controlled heating and cooling of the part, additionally reducing distortion and therefore providing some control to distortion of the built part.

As is apparent from the above, the invention is a method and apparatus for 3D metal printing manufacturing of a part, created from a computer-generated model which includes sliced layers with a finite dimension, in a weldable material by solid freeform fabrication, unrestricted in part size, which utilises one or both of (a) a protective inert gas shield that surrounds the electric arc and subsequent cooling molten metal and (b) an induction heating and closed loop cooling apparatus for temperature control of both the substrate and layered 3D printed part during the sequentially layered weld bead operation.

The use of the protective inert gas shield, which can also be described as a localised inert gas diffuser apparatus, and/or the induction heating and cooling apparatus, makes it possible to increase volumetric deposition layer by layer for weldable metals, in particular, such as carbon manganese alloys, aluminium alloys, nickel alloys and titanium or titanium alloys and titanium alloy objects.

The entire build envelope of the 3D printed part may use a similar substrate metal to deposit the initial and subsequent weld bead layers that form the final part, without the need for commissioning an entirely enclosed chamber or using contained sealed protective procedures to avoid oxidising the newly deposited sequential layers of molten weld metal or the associated molten area.

The computer-generated model of the part may be separated into a set of parallel layered slices with a finite dimension, and each layered slice may be divided into a set of sequential virtual one-dimensional pieces. The term “virtual one-dimensional pieces” as used herein means longitudinal bead resembling pieces of the weld bead material geometry which, when deposited side by side or stacked one upon another in a specific sequential pattern according to the direction specific to the model, will form the part that is to be manufactured. The term “computer-generated direction specific, layered model of the part” as used herein means a three dimensional computerized illustration of the piece which is to be shaped.

The computer-generated model may comprise dimensional and weld bead geometry data in all directions and be given a three dimensional design which resembles the three dimensional design of the metallic part that is to be manufactured. The computer-generated, direction specific, layered model may then be applied to the freeform fabrication equipment as a template to construct the physical metallic part. That is, the computer-generated model may be transformed into a specific set of instructions implemented by the control system of the solid freeform fabrication equipment such that the metallic part is being manufactured sequentially by welding a wire onto a substrate in sequential lines, where each welded layer corresponds to a slice of the computer-generated, direction specific, layered model. The invention may apply any known or credible software for computer assisted design for creating the computer-generated, direction specific, layered model.

During the welding of aluminium alloys, stainless steels, nickel or nickel alloys, titanium or titanium alloy or other reactive metal parts, inert gas protection is required to prevent sensitisation or destruction of the protective oxide layer such that this protective layer is oxidised and therefore may affect the final physical and mechanical properties of the final formed part. Therefore, the oxygen surrounding the electric arc and subsequent molten material may be completely displaced by applying a flow of argon or argon mixture gas in a stable continuous mode at predetermined flow-rate settings that give a laminar or any other suitable flow through a series of numerous gas diffuser outlets and/or through a filter such as a sintered bronze filter, in the bottom of a gas manifold compartment, or by any other supply options to the compartment, by typically inserting only the same amount of inert gas as the volume of the compartment and still obtain an oxygen content in the inert argon atmosphere, typically of less than 500 ppm oxygen or less than 100 ppm oxygen. Typically, the gas manifold compartment may be 80 to 180 mm wide and 180 to 400 mm long, or may be a cylindrical shape of less than 400 mm in diameter.

Gas flow into the gas manifold compartment may be via a manifold located within the purge apparatus and gas flows through the manifold, distributed accordingly through the gas diffuser nozzles and/or the filter which displaces the oxygen in the weld zone. The inlet tube may distribute and control the flow of gas into the manifold via an electronically controlled valve, which has an ability to control the flow rate, pressure and volume of gas continuously or periodically, creating a pulsed delivery of inert gas to the weld zone. This feature of the purge apparatus gives the advantage of using less volumes of costly inert gas.

The gas manifold compartment may also include a closed cooling circuit where a separate inert gas is passed through a heat-exchanger to lower the temperature of the inert gas flowing through the manifold, and then this gas may be circulated via a recycle distribution loop that flows through the manifold tubes providing the localised shielding to the weld zone. This feature is advantageous to avoid overheating of the localised purge apparatus and to a limited extent also the welding torch.

A 6-axis or greater robot may be used to control the position and movement of a welding torch with wire feeder for feeding a wire consumable of the weldable material, ideally positioned above the build envelope of the part to be manufactured. The robot may also be governed by the size of the substrate. The localised purge apparatus may be mounted to a bracket arm structure that mounts the welding torch and related wire feeder holding device, which is mechanically attached to the robot. The localised purge apparatus may be equipped with at least closable gas diffuser outlets and at least five closable gas inlets connected to the tube manifold in order to displace oxygen from the weld zone and substitute this gas with a controlled surrounding inert gas. The purge apparatus may incorporate the weld torch device in an interchangeable manner.

The invention may apply any known or conceivable control system for the operating movement of the electric arc welding torch, localised gas purging apparatus, and wire stock feeder. The operating movement may advantageously be furnished with a six axis robotic control system (X,Y,Z, and three or more rotation axis points). The operating movement may also be in the form of any known or conceivable gantry mounted systems (X,Y,Z) and the mounting table may be stationary or move in the X,Y,Z directions relative to the mounted electric arc welding torch. The invention may apply any known or conceivable welding torch and wire stock feeder system able to perform weld layered manufacturing of metallic parts by the welding processes known as tungsten inert gas welding (GTAW), gas metal arc welding (GMAW) and plasma transferred arc welding (PTAW).

The induction element for pre-heating the substrate and weld layers may be synergic controlled with the welding and robotic control system. Synergic closed looped control (of the 3 controllers) allows increased temperatures of the substrate and the deposited weld bead layers such that the welding parameters may be altered linearly from pre-set data in a fashion that increases weld bead geometry, therein increasing metal deposition, and therein increasing welding speeds.

The induction heating apparatus may be any commercially available system, electromagnetic in nature, preferably connected to the substrate where induction is initiated prior to the weld bead layering process. Application of preheating not only increases the weld bead size and deposition speeds but it also reduces distortion and internal residual stresses of the final 3D printed part. This offers an advantage over other known 3D metal printing processes. The application of controlled synergic induction heating relative to the welding process parameters may be enhanced further by known data that optimises the incremental application during the weld bead layering process, so that favourable physical and mechanical properties can be achieved for the final 3D printed part.

The cooling apparatus may be any commercially available system which is closed loop in nature and is preferably connected to the substrate via inlet and outlet fittings which circulate coolant through cooling channels within the substrate. Flow rates can vary depending on the metallic material type. Application of cooling assists in some cases where the desired mechanical properties of the 3D printed part are enhanced by more rapid cooling. Rapid cooling offers the advantage of decreasing the time between layers, and thus decreasing overall build times.

The temperature of the physical part during the weld bead layering process may be increased up to the softening point, for any weldable material. For example, in case of 3D metal layering of titanium or its alloys, the temperature may be as high as 800° C. during the layered fabrication of the part. However, this will have a corresponding change to the heat source parameters of the electric arc and its delivery of the melted wire, wherein the electric arc parameters enhance the weld bead deposition. Beneficially, this can provide significant reductions in production times for parts manufactured in accordance with the invention.

### BRIEF DESCRIPTION OF THE DRAWINGS

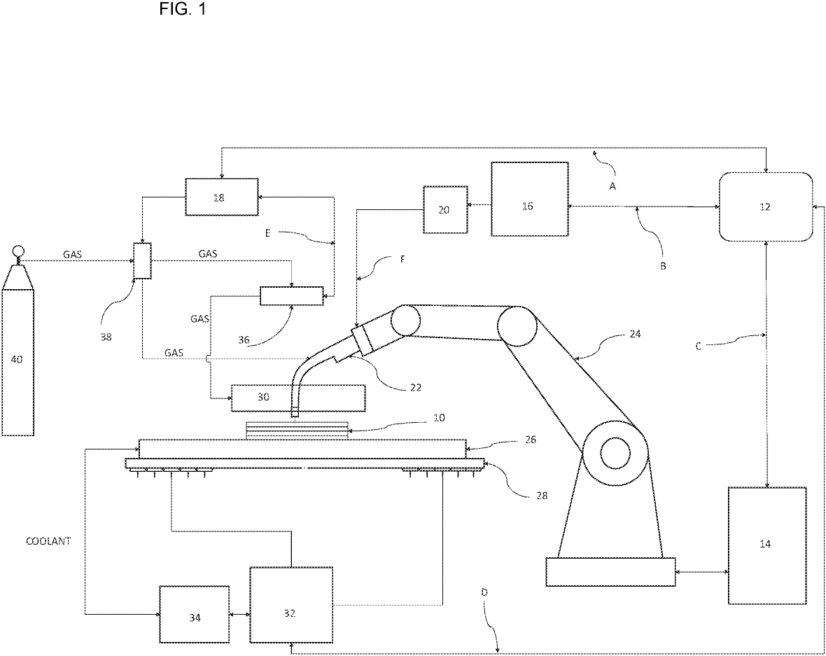

One embodiment of the manufacturing method and apparatus of the present invention is shown in the schematic drawing of FIG. 1. FIG. 1 shows the construction of a metallic part 10 by welding a piece of weldable material onto a first layer by an electric arc welding process that melts a wire consumable of the weldable material using a weld bead layering technique to provide freeform fabrication.

### DETAILED DESCRIPTION OF PREFERRED EMBODIMENT

With reference to FIG. 1, illustrated is a computer 12 providing feedback signals A,B,C,D,E for the control of a robot power supply 14, a welder power supply 16, an activating solenoid valve 36, an induction heating apparatus 32 and a solenoid controller 18. The welder power supply 16 also provides power and control for a wire feeder 20. Wire is fed via F to a welding torch 22 that is a part of the robot 24, which in this form is an electric arc transferred plasma welding torch. An electric arc may alternatively be transferred via a tungsten inert gas welding torch, again with a wire feeder 20 of similar weldable material. Further, an electric arc may be transferred via a wire consumable using a gas metal inert welding torch.

The gas supply system includes a shielding gas feed cylinder 40 supplying an 8/2 solenoid valve 36 to activate the gas going to a purge apparatus 30, via a further solenoid splitter valve 38. Feedback signals provide suitable control via the solenoid controller 18.

The metallic part 10 being welded in the layer-by-layer process described above is layered on a suitable substrate 26 supported by a substrate cooling bed 28. A purge apparatus 30 is positioned above the metallic part 10 to shield the deposited weld in the manner generally described above. Actuators for the robot 24 and the torch, and for the purge apparatus 30, are shown located outside the boundary limits of the build area, the substrate 26, and a high energy heat source 32.

The substrate 26 and subsequent metal layering is pre-heated and maintained using an induction heating apparatus 32, which is synergic controlled during the metal layering operation. Induction heating during the process enhances increased metal deposition and provides a means of distortion control for the final part 10.

The substrate 26 in this embodiment includes cooling channels (not shown) to further control the temperature of the metal part 10. The cooling apparatus 34 is closed loop in nature and is connected to the substrate via fittings which circulate coolant through the cooling channels. Cooling offers the advantage of decreasing the time between layers, thus decreasing overall build times for a completed 3D printed part.

This embodiment of the method and apparatus of the invention provides a high deposition method and apparatus for manufacturing 3D metal parts, which includes localised atmospheric protection and solid freeform fabrication unrestricted in size and open to the ambient atmosphere, in particular for the manufacture of parts made of carbon manganese alloys, aluminium alloys, nickel alloys, stainless steels and titanium alloys.

As mentioned above, the apparatus has no restriction to build or part size, or area size, and is open to the ambient atmosphere, wherein the molten weld pool and neighbouring area is shielded by the localised apparatus used for distributing a generous but controlled laminar inert gas flow. Gas flow distribution is located above the build area and given a design such that the gas distribution flows evenly and equally around the weld pool area and solidifying molten metal.

Many modifications may be made to the embodiment of the invention described in relation to FIG. 1 without departing from the spirit and scope of the invention.

What is claimed is:

1. A method of manufacturing a metallic part in a weldable material by solid freeform fabrication unrestricted in size and open to the ambient atmosphere, wherein the method comprises:
generating a computer-generated, three dimensional model of the part, slicing the computer-generated three dimensional model into a set of computer- generated, parallel, sliced layers and then dividing each layer into a set of computer-generated, virtual, one-dimensional pieces and, with reference to layered weld-bead geometry data, forming a computer-generated, direction specific, layered model of the part,
uploading the direction specific, layered model of the part into a welding control system able to control the position and activation relative to a support substrate, of an electric arc delivered by a high energy tungsten arc welding torch, a plasma transferred arc welding torch, and/ or a gas metal arc welding torch, and a system for feeding a consumable wire placed in an open area build space relevant to the substrate unrestricted in size and open to the ambient atmosphere for generating molten metal,
directing the welding control system to deposit a sequence of one-dimensional weld beads of the weldable material onto the supporting substrate in a pattern required to form a first layer of the computer-generated, direction specific, layered model of the part,
depositing a second welded layer by sequencing one- dimensional weld beads of the weldable material onto the previous deposited layer in a configuration the same as the second layer of the computer-generated direction specific layered model of the part, and
repeating each successive weld bead layer of the computer-generated, direction specific, layered model of the part until the entire part is completed;
wherein the method further includes:
displacing the atmosphere within the immediate vicinity of the heat source and the molten metal with an atmosphere of inert gas which produces a required flow rate, and in which that inert atmosphere contains a maximum oxygen concentration, wherein the inert gas is delivered by an apparatus through a matrix of individual gas diffusers and includes a gas manifold compartment that is 80 to 180 mm wide and 180 to 400 mm long or that is of a cylindrical shape up to 400 mm in diameter; and
engaging an induction heating and closed loop cooling apparatus synergic to a welding control system and pre-heating the substrate material including the deposited weld beads, relevant to the type of weldable material, wherein induction heating and cooling cycles are applied constantly or pulsed from the first layer to the final layer, where optimal heating and/ or cooling cycles of the weldable material are relative to the final desired part shape and microstructure.

2. A method according to claim 1, wherein the weldable material is a weldable metal, or a weldable alloyed metal, of ferrous or non-ferrous nature.

3. A method according to claim 2, wherein the weldable material is carbon steel or carbon manganese alloys, nickel or nickel alloys, stainless steels, aluminium or aluminium alloys, titanium or alloyed titanium, ferrous or non-ferrous, or a mixture of dissimilar weldable materials.

4. A method according to claim 1, wherein the inert gas is one of argon, helium, hydrogen, nitrogen, or a mixture of these.

5. A method according to claim 1, wherein the inert gas shielding the electric arc and heat-affected material is argon or an argon mixture, and where the flow rate of the argon or argon mixture is constant or pulsed and above 20 liters per minute, and wherein the distribution of the inert gas is delivered through a series of gas diffusers.

6. A method according to claim 1, wherein the required flow rate is greater than 20 1/min.

7. A method according to claim 1, wherein the maximum oxygen concentration is less than 500 ppm oxygen.

8. A method according to claim 1, wherein there are less than 25 individual gas diffusers.

9. Production apparatus for a part made of a weldable material by solid freeform fabrication, where there is no enclosure or reactor required, and the part is built in an unrestricted build environment open to the ambient atmosphere by an apparatus which distributes an inert gas flow, the production apparatus including:
a robotic multiple-axis mechanism controlling the position and movement of a welding torch with a wire feeder relative to a stationary support substrate placed upon a fixed support, the welding torch being an electric arc welding process, a tungsten arc welding torch, a gas metal arc welding torch, or a plasma transferred arc welding torch;
a support mechanism controlling the position and movement of the welding torch and the wire feeder relative to the support substrate, and an actuator controlling the position and movement relative to the support mechanism; and
a control system able to read a computer-generated, three dimensional, direction specific, layered model of the part and employ the computer-generated model to control the position and movement of the robotic multiple-axis mechanism, and the operation of the welding torch and wire, feeder such that a part is built by welding in a layer-by-layer sequence according to one-dimensional slices of the weldable material onto the substrate structure in agreement with the computer- generated, three dimensional, direction specific, layered model of the part;
the apparatus also including a localised purging apparatus and an induction heating and closed loop cooling apparatus.

10. Apparatus according to claim 9 wherein the localised purging apparatus includes a manifold filled with argon or argon mixture as inert gas, and a gas inlet, where the gas inlet is equipped with means for regulating the gas flow rate.

11. Apparatus according to claim 9 wherein the induction heating apparatus is capable of heating the substrate and subsequent weld bead layers.
